(19) United States
(12) Patent Application Publication
(10) Pub. No.: US 2011/0141073 A1
(43) Pub. Date: Jun. 16, 2011

(54) PIXEL ARRAY

(76) Inventors: Sheng-Chao LIU, Hsinchu (TW); Kuang-Hsiang Liu, Hsinchu (TW)

(21) Appl. No.: 12/844,545

(22) Filed: Jul. 27, 2010

(30) Foreign Application Priority Data
Dec. 10, 2009 (TW) 098142247

(51) Int. Cl. G09G 5/00

(52) U.S. Cl. 345/205

(57) ABSTRACT

A pixel array which comprises a display area, a plurality of scan lines and a plurality of drivers is provided. The display area has a first side, a second side in opposition to the first side and a plurality of pixels. The scan lines are electrically connected to the pixels, respectively. The drivers are electrically connected to the scan lines, respectively. The pixels are arranged along the first direction in sequence. The drivers are located on the first side and the second side of the display area, and are arranged along the second direction in sequence. The first direction is orthogonal to the second direction.

This application claims the benefit from the priority of Taiwan Patent Application No. 098142247 filed on Dec. 10, 2009, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a pixel array. More particularly, the present invention relates to a pixel array with a circuit layout of drivers arranged in a two-dimensional manner.

2. Descriptions of the Related Art

Over recent years, flat panel displays have developed more rapidly and have gradually replaced conventional cathode ray tube (CRT) displays. The flat panel displays that are currently available mainly fall into the following categories: organic light-emitting diode (OLED) displays, plasma display panels (PDPs), liquid crystal displays (LCDs), field emission displays (FEDs) and the like. Because flat panel displays save energy, are free from radiation and have a small volume, low power consumption, little space occupation, flat screen, high resolution and stable picture quality, the displays have found a wide application in electronic products, such as mobile phones, screens, digital TV sets and notebook computers for use to display images.

As the number of pixels of flat panel displays increases and the volume of electronic products shrinks increasingly, the size of panel frames of the flat panel displays have substantial influence on the volume of electronic products.

As shown in FIG. 1A and FIG. 1B, a pixel array 1 of a conventional flat panel display comprises a display area 11 and a plurality of drivers 151, 152, 153, . . . , 15m. The display area 11 comprises m rows (131, 132, 133, . . . , 13m)×n columns (111, 112, 113, . . . , 11n) of pixels; i.e. the display area 11 comprises m×n pixels. Pixels in each row are electrically connected to a single driver simultaneously. For example, pixels in the first row 131 of the display area 11 are simultaneously electrically connected to the driver 151; pixels in the second row 132 of the display area 11 are simultaneously electrically connected to the driver 152; and so on, and finally, pixels in the m^{th} row 13m of the display area 11 are simultaneously electrically connected to the driver 15m. The pixels of the display area 11 will be turned on respectively in sequence according to the timing sequence of a plurality of scan signals generated by the drivers 151, 152, 153, . . . , 15m.

Furthermore, as can be seen from FIG. 1A and FIG. 1B, when a pixel decreases in size (as shown in FIG. 1B), a height of the pixel will decrease accordingly. To maintain a spatial interval period of a circuit layout of the drivers 151, 152, 153, . . . , 15m, flat panel display manufacturers tend to enlarge a length of the circuit layout of the drivers 151, 152, 153, . . . , 15m, resulting in an increase in a frame length of the flat panel display.

In summary, efforts still have to be made in the art to provide a flat panel display with a diminished length of a circuit layout of drivers and an increased number of pixels without dramatically altering the construction of the conventional pixel array and the circuit layout of drivers.

### SUMMARY OF THE INVENTION

An objective of the present invention is to provide a pixel array. The pixel array comprises a display area and a plurality of drivers. The display area has a first side, a second side in opposition to the first side and a plurality of pixels. The drivers are electrically connected to the pixels respectively. Wherein, the pixels are arranged along a first direction in sequence. The drivers are located on the first side of the display area and the second side of the display area, and are arranged along a second direction in sequence. The first direction is orthogonal to the second direction.

The other objective of the present invention is to provide a pixel array. The pixel array comprises a display area, a plurality of scan lines and a plurality of drivers. The display area has a first side, a second side in opposition to the first side and a plurality of pixels. The scan lines are electrically connected to the pixels respectively. The drivers are electrically connected to the scan lines respectively. Wherein, the pixels are arranged along a first direction in sequence to form a plurality of pixel rows, and are arranged along a second direction in sequence to form a plurality of pixel columns. The drivers are located on the first side of the display area and the second side of the display area, and are arranged along the second direction. The first direction is orthogonal to the second direction.

In summary, the pixel array of the present invention has a circuit layout of drivers arranged in a two-dimensional manner. Accordingly, in the pixel array, the circuit layout of drivers has a length thereof diminished so that a frame length of a flat panel display incorporating the pixel array of the present invention is diminished, thereby reducing a volume of the flat panel display.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A to 1B are schematic views of a pixel array of a conventional flat panel display;

FIGS. 2A to 2J are schematic views of a first embodiment of the present invention; and

FIGS. 3A to 3J are schematic views of a second embodiment of the present invention.

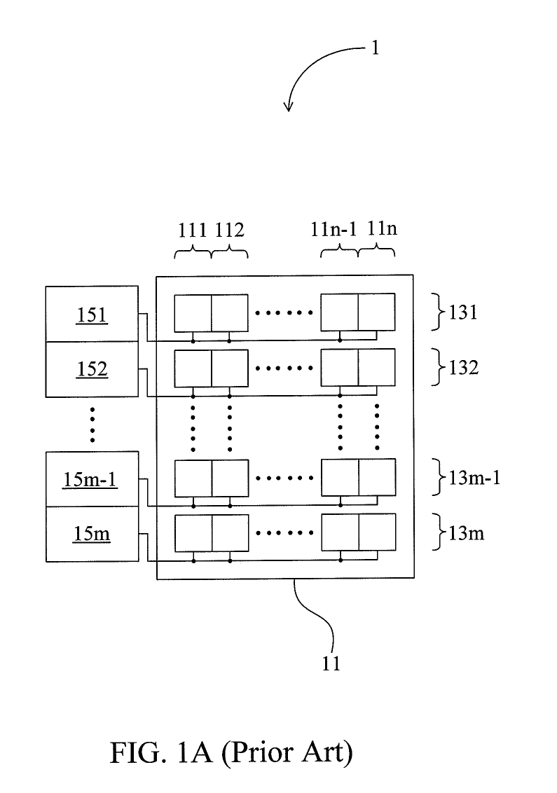

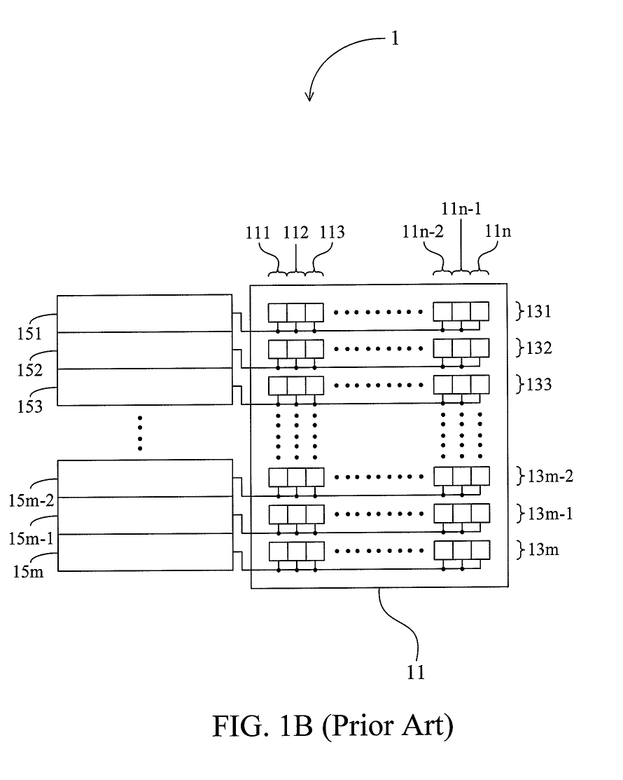

### DESCRIPTION OF THE PREFERRED EMBODIMENT

In the following description, the present invention will be explained with reference to embodiments thereof. The present invention provides a pixel array for use in a flat panel display, which may be one of the following flat panel displays: an OLED display, a PDP, an LCD and an FED. However, description of these embodiments is only for purposes of illustration. It should be appreciated that in the following embodiments and the attached drawings, elements unrelated to the present invention are omitted from depiction; and dimensional relationships among individual elements in the attached drawings are illustrated only for ease of understanding, but not to limit the actual scale.

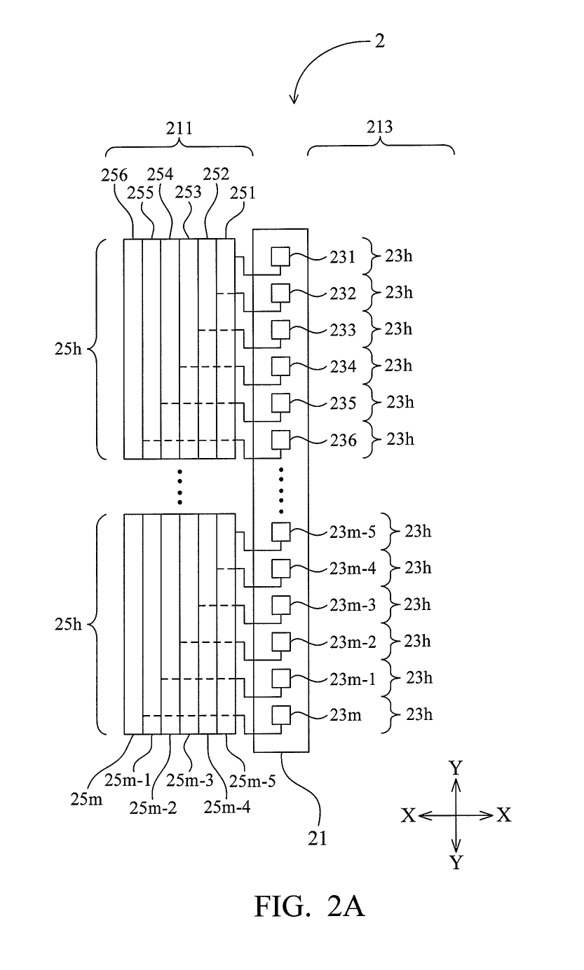

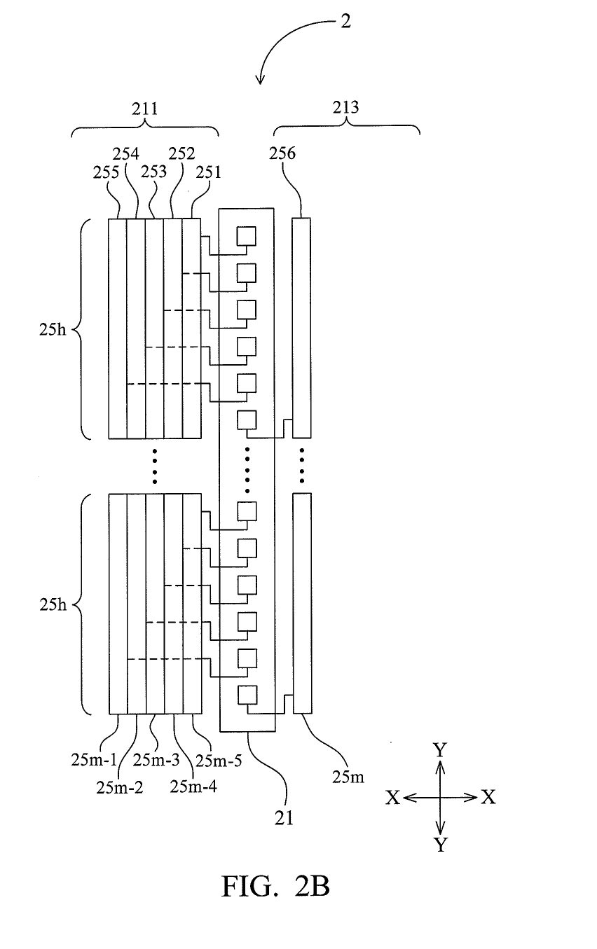

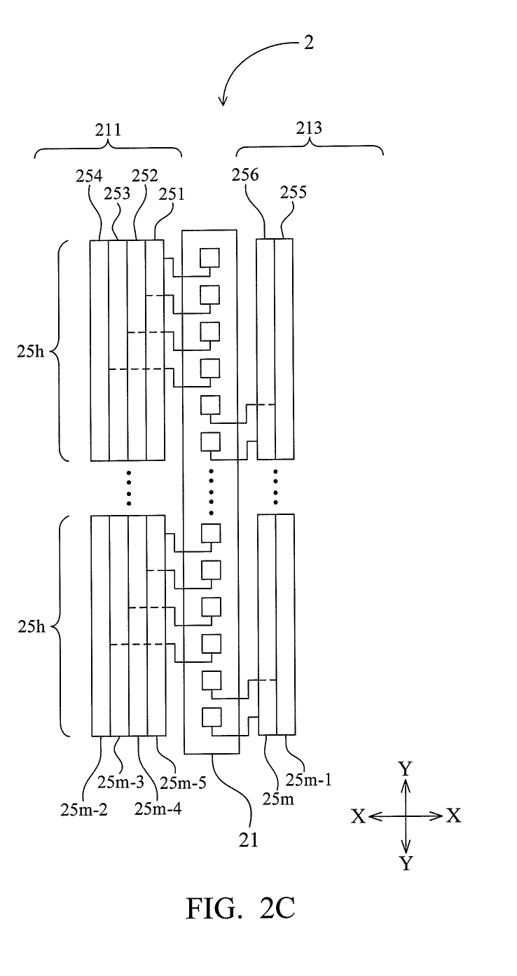

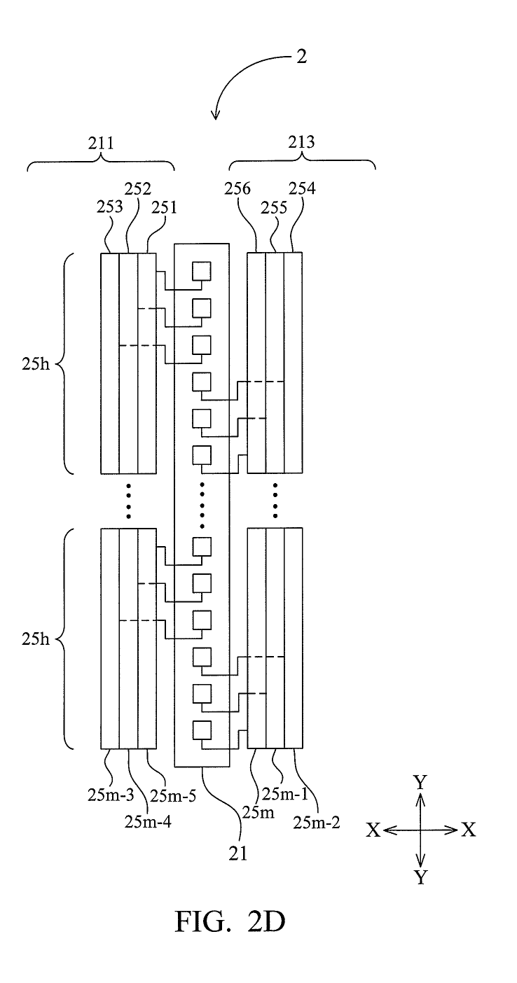

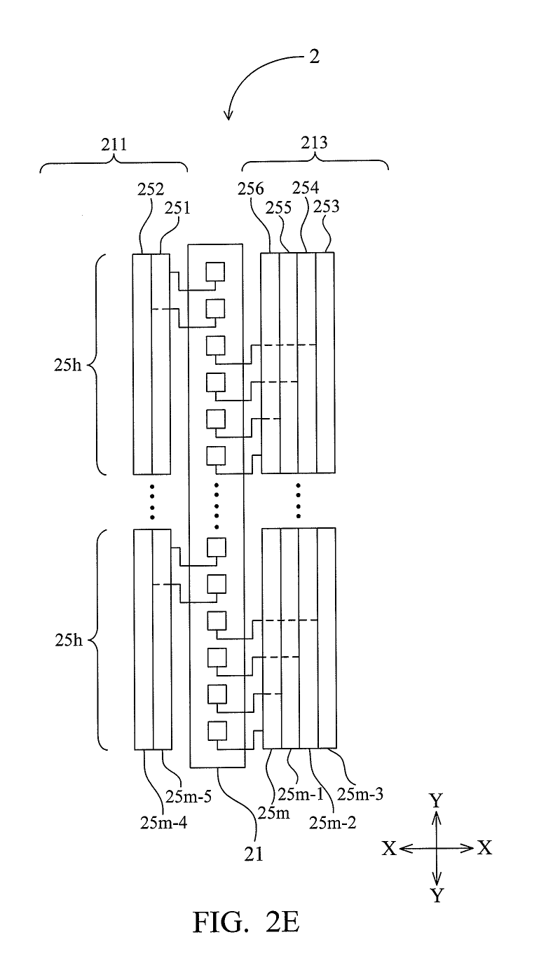

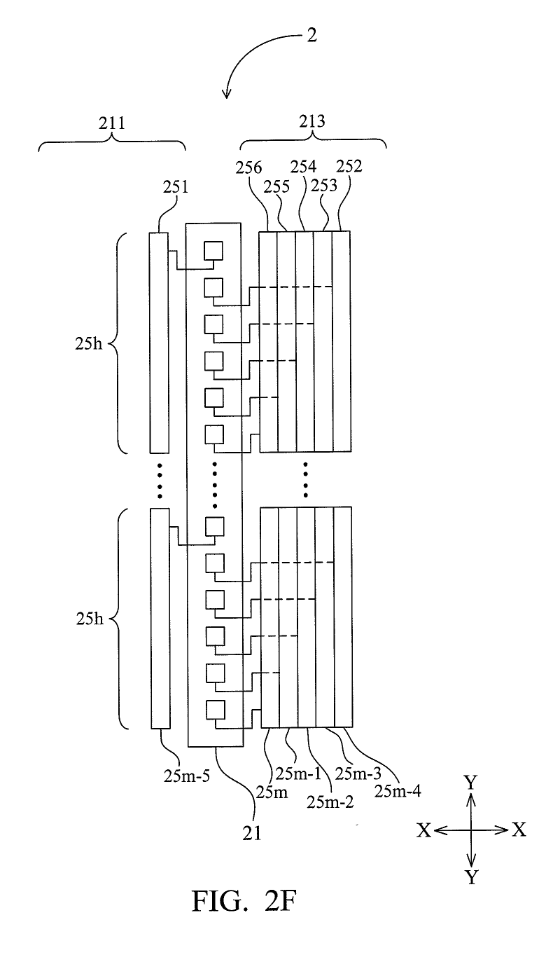

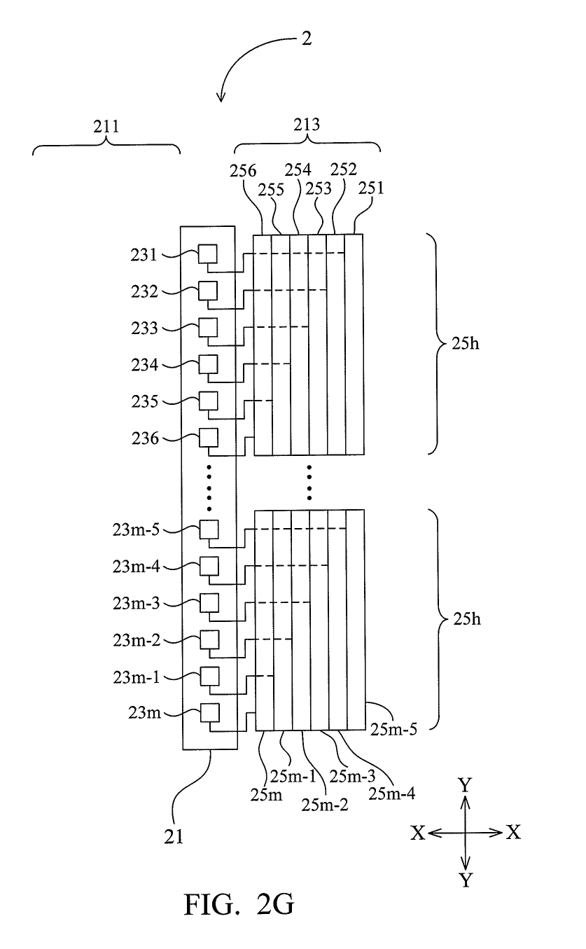

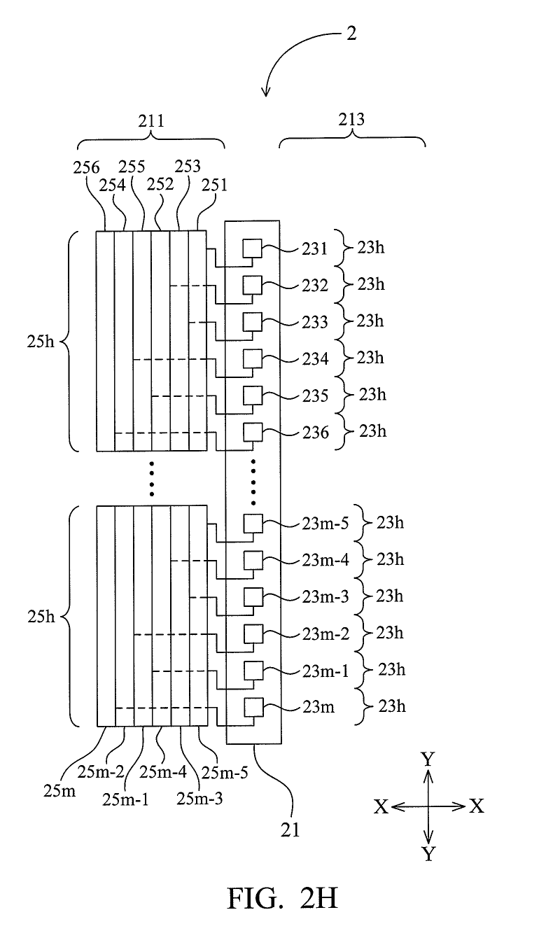

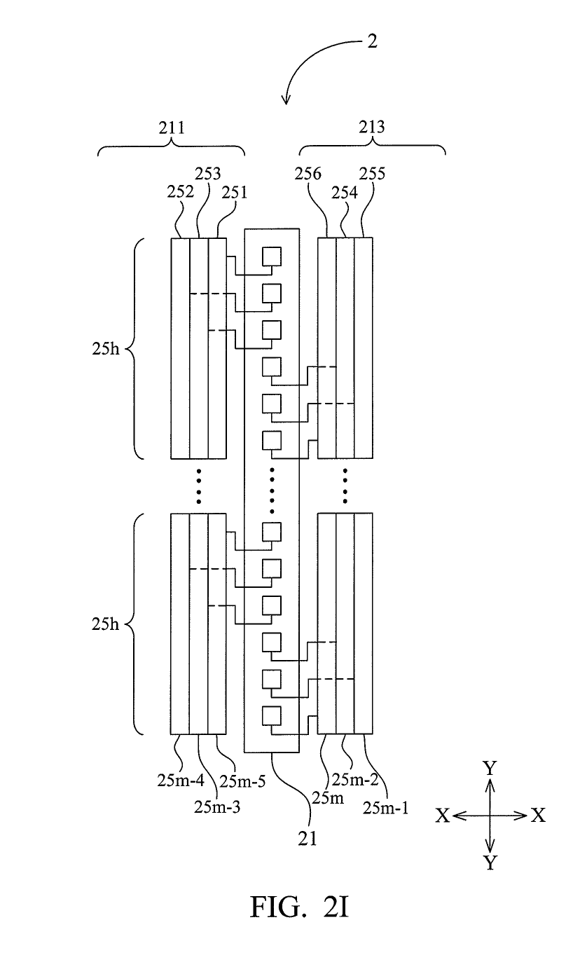

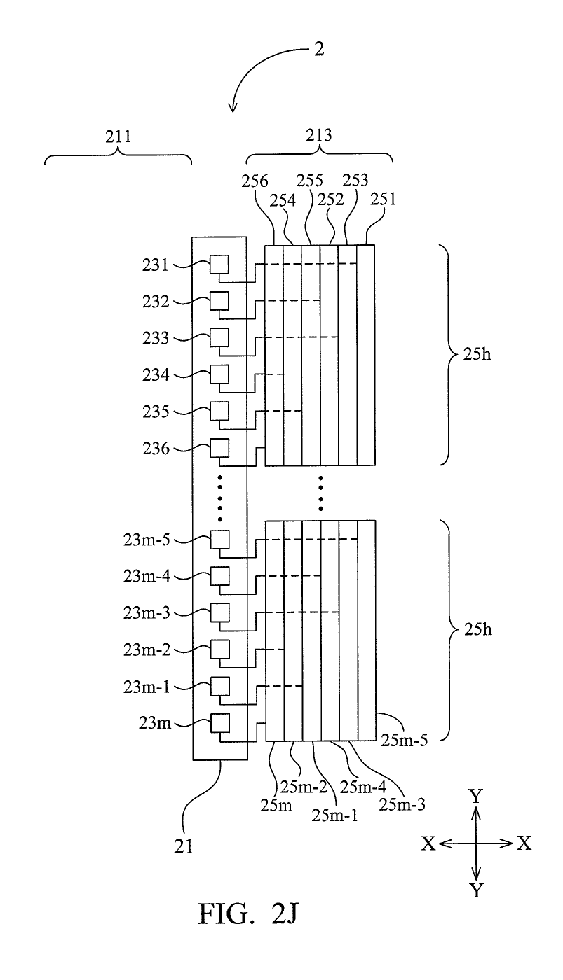

FIGS. 2A to 2J are schematic views of a first embodiment of a pixel array of the present invention. The pixel array 2 comprises a display area 21 and a plurality of drivers 251, 252, 253, . . . , 25m. For purposes of simplicity, in FIGS. 2A to 2G, only the first driver 251, the second driver 252, the third driver 253, the fourth driver 254, the fifth driver 255 and the sixth driver 256 are shown to represent m drivers of the pixel array 2. The drivers 251, 252, 253, . . . , 25m may have different types of drivers such as unidirectional shift registers or bidirectional shift registers.

The display area 21 has a first side 211, a second side 213 in opposition to the first side 211 and a plurality of pixels 231, 232, 233, . . . , 23m. The pixels 231, 232, 233, . . . , 23m are arranged along a first direction (Y direction) in sequence and have a height 23h respectively. Similarly, for purposes of simplicity, in FIGS. 2A to 2G, only the first pixel 231, the second pixel 232, the third pixel 233, the fourth pixel 234, the fifth pixel 235 and the sixth pixel 236 are shown to represent m pixels of the display area 21.

Each pixel is electrically connected to a driver. For example, the first pixel 231 is electrically connected to the first driver 251; the second pixel 232 is electrically connected to the second driver 252; and so on. Finally, the m^{th} pixel 23m is electrically connected to the m^{th} driver 25m. The plurality of pixels 231, 232, 233, . . . , 23m of the display area 21 will be turned on respectively in sequence according to a timing sequence of a plurality of scan signals generated by the drivers 251, 252, 253, . . . , 25m.

Furthermore, each of the drivers 251, 252, 253, . . . , 25m of the pixel array 2 has a height 25h, which is an even multiple or an odd multiple of the aforesaid height 23h of each of the pixels.

As shown in FIG. 2A, in the pixel array 2 of the first embodiment, the height 25h of each of the drivers 251, 252, 253, . . . , 25m is six times the height 23h of each of the pixels. Accordingly, the drivers 251, 252, 253, . . . , 25m will be arranged in groups of six (for example, with the first driver 251, the second driver 252, the third driver 253, the fourth driver 254, the fifth driver 255 and the sixth driver 256 forming a group), on the first side 211 of the display area 21 along a second direction (X direction) orthogonal to the first direction (Y direction) in sequence to form a circuit layout of drivers arranged in a two-dimensional manner.

It should be particularly noted that the drivers 251, 252, 253, . . . , 25m which are arranged in groups of a plurality of drivers are not limited to be located on the first side 211 of the display area 21 in the present invention. Those of ordinary skill in the art may locate the drivers 251, 252, 253, . . . , 25m on the first side 211 and the second side 213 of the display area 21 respectively depending on practical requirements.

As shown in FIG. 2B, the first driver 251, the second driver 252, the third driver 253, the fourth driver 254 and the fifth driver 255 are arranged on the first side 211 of the display area 21 along the second direction (X direction) orthogonal to the first direction (Y direction) in sequence, while the sixth driver 256 is located on the second side 213 of the display area 21.

As shown in FIG. 2C, the first driver 251, the second driver 252, the third driver 253 and the fourth driver 254 are arranged on the first side 211 of the display area 21 along the second direction (X direction) orthogonal to the first direction (Y direction) in sequence, while the fifth driver 255 and the sixth driver 256 are arranged on the second side 213 of the display area 21 along the second direction (X direction) orthogonal to the first direction (Y direction) in sequence.

As shown in FIG. 2D, the first driver 251, the second driver 252 and the third driver 253 are arranged on the first side 211 of the display area 21 along the second direction (X direction) orthogonal to the first direction (Y direction) in sequence, while the fourth driver 254, the fifth driver 255 and the sixth driver 256 are arranged on the second side 213 of the display area 21 along the second direction (X direction) orthogonal to the first direction (Y direction) in sequence.

As shown in FIG. 2E, the first driver 251 and the second driver 252 are arranged on the first side 211 of the display area 21 along the second direction (X direction) orthogonal to the first direction (Y direction) in sequence, while the third driver 253, the fourth driver 254, the fifth driver 255 and the sixth driver 256 are arranged on the second side 213 of the display area 21 along the second direction (X direction) orthogonal to the first direction (Y direction) in sequence.

Further as shown in FIG. 2F, the first driver 251 is located on the first side 211 of the display area 21, while the second driver 252, the third driver 253, the fourth driver 254, the fifth driver 255 and the sixth driver 256 are arranged on the second side 213 of the display area 21 along the second direction (X direction) orthogonal to the first direction (Y direction) in sequence.

Also as shown in FIG. 2G, the first driver 251, the second driver 252, the third driver 253, the fourth driver 254, the fifth driver 255 and the sixth driver 256 are all arranged on the second side 213 of the display area 21 along the second direction (X direction) orthogonal to the first direction (Y direction) in sequence.

Meanwhile, as shown in FIGS. 2H to 2J, the present invention also has no limitation on the sequence in which the drivers 251, 252, 253, . . . , 25m are arranged; i.e. the drivers 251, 252, 253, . . . , 25m may be arranged on the first side 211 and/or the second side 213 of the display area 21 in an interlaced manner. Those of ordinary skill in the art may locate the drivers 251, 252, 253, . . . , 25m on the first side 211 and the second side 213 of the display area 21 in different arrangement sequences depending on practical requirements.

Thus, the pixel array 2 described in the first embodiment has a circuit layout of the drivers 251, 252, 253, . . . , 25m arranged in a two-dimensional manner. Accordingly, in the pixel array 2, the circuit layout of the drivers 251, 252, 253, . . . , 25m has a length thereof diminished so that a frame length of a flat panel display incorporating the pixel array 2 is diminished accordingly.

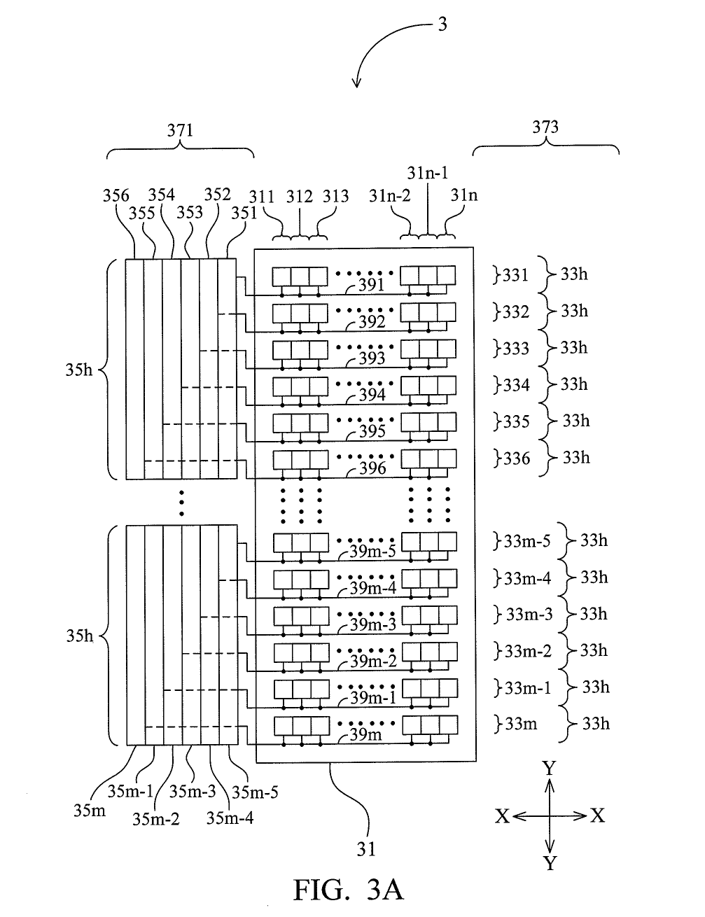

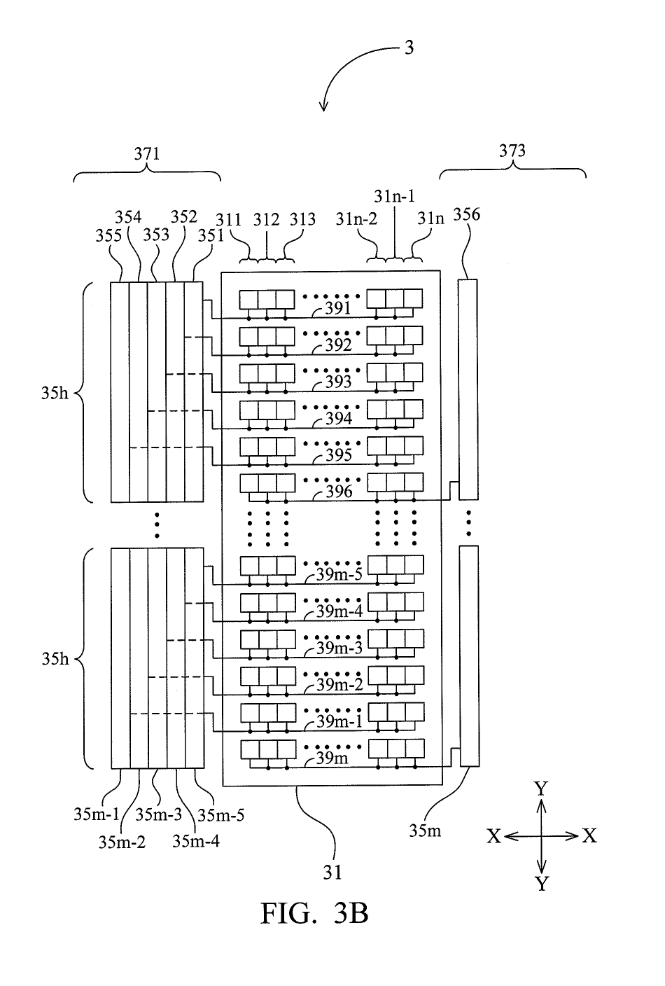

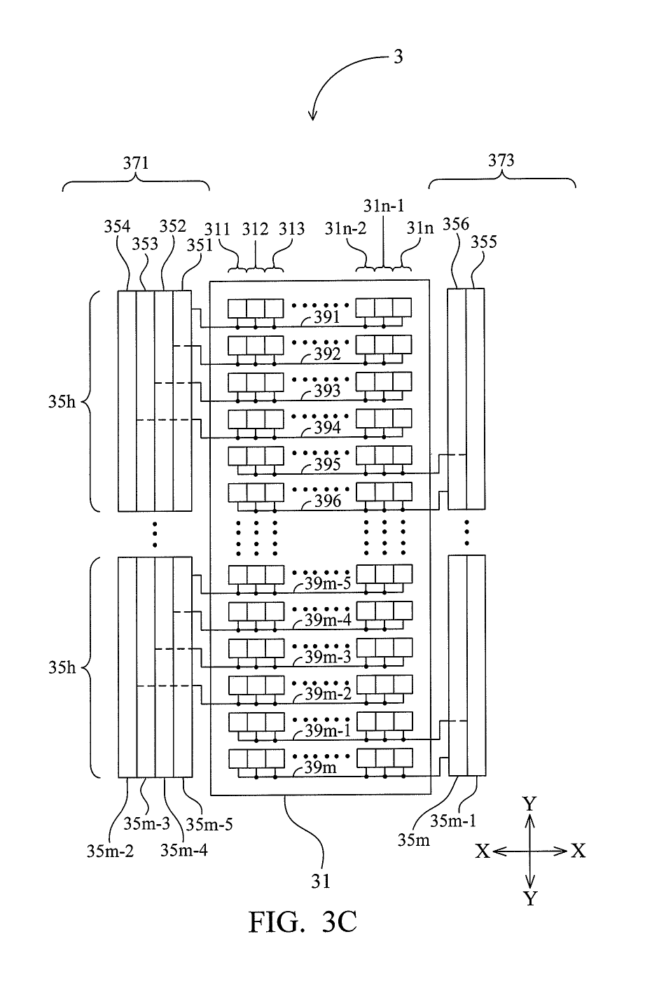

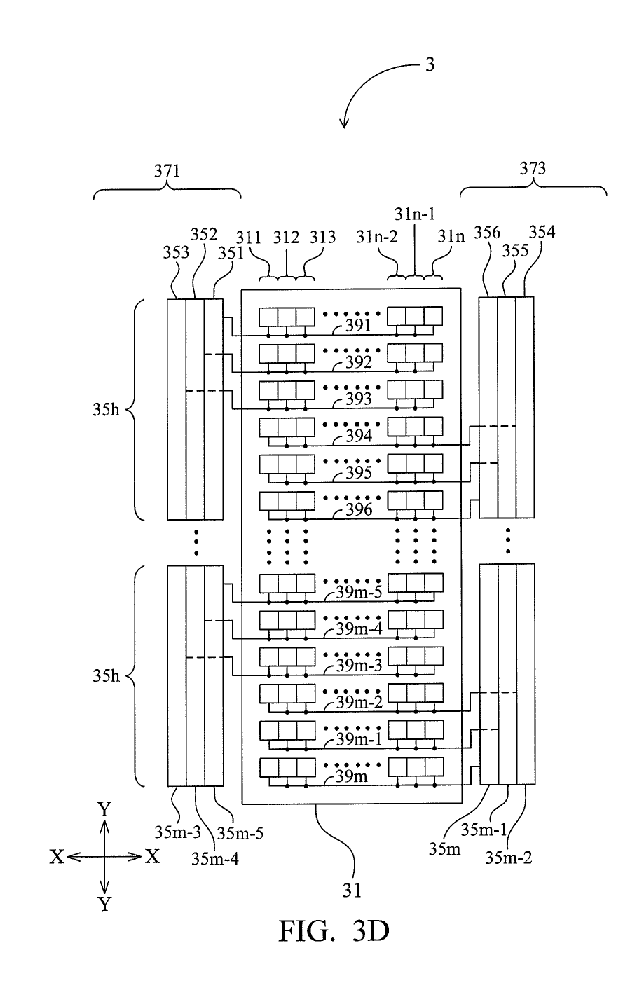

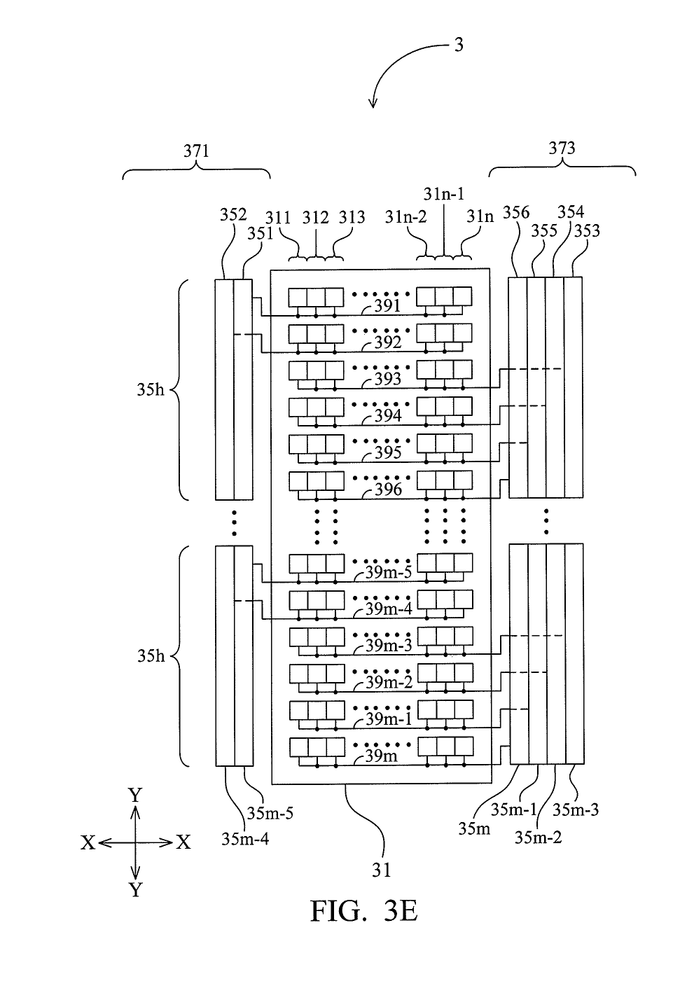

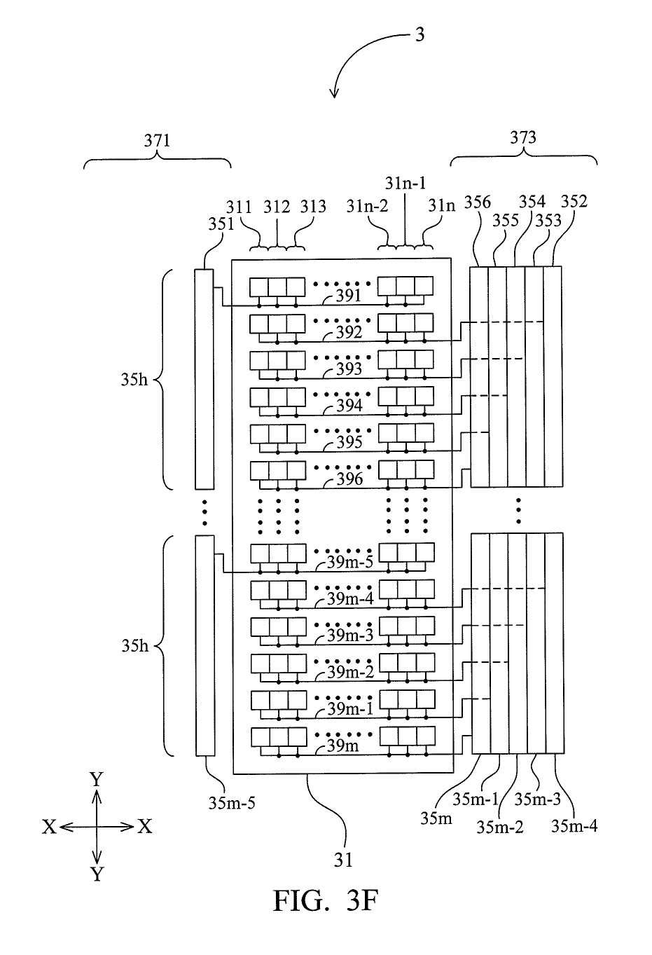

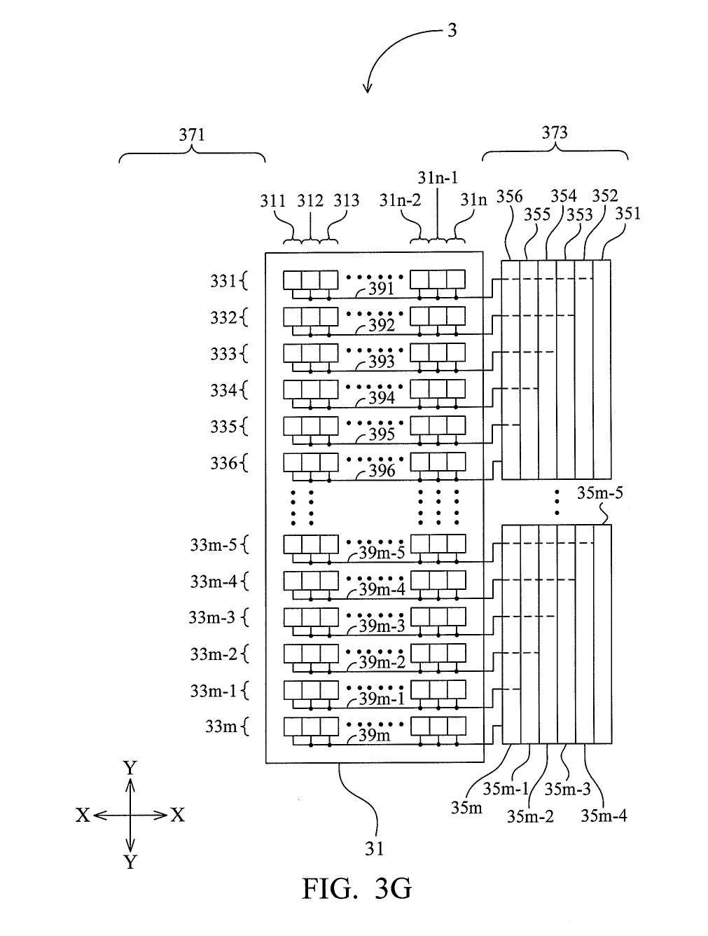

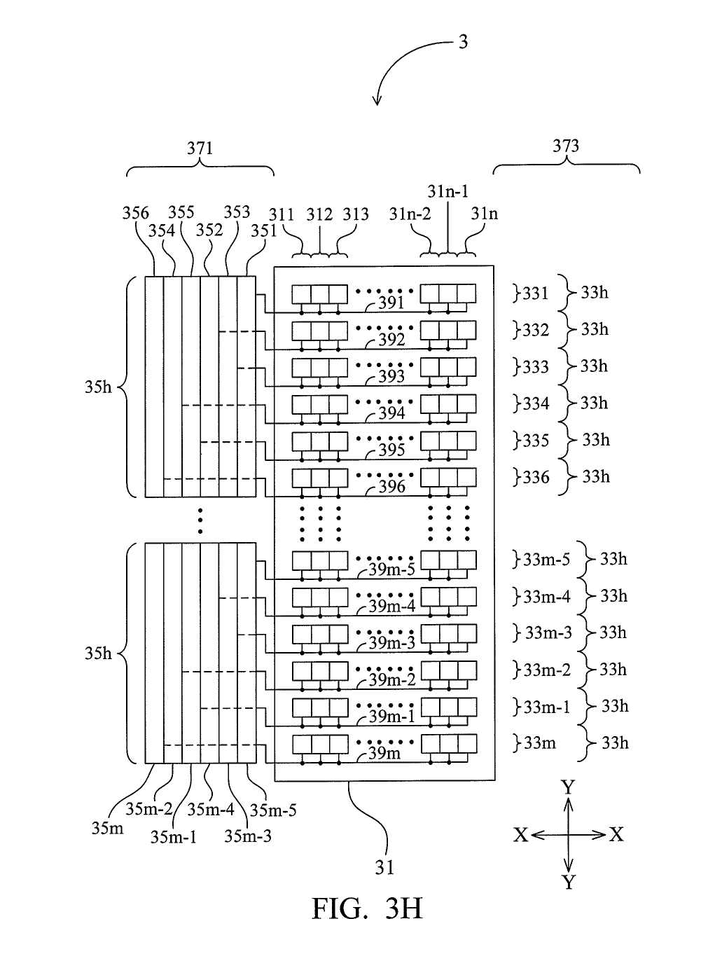

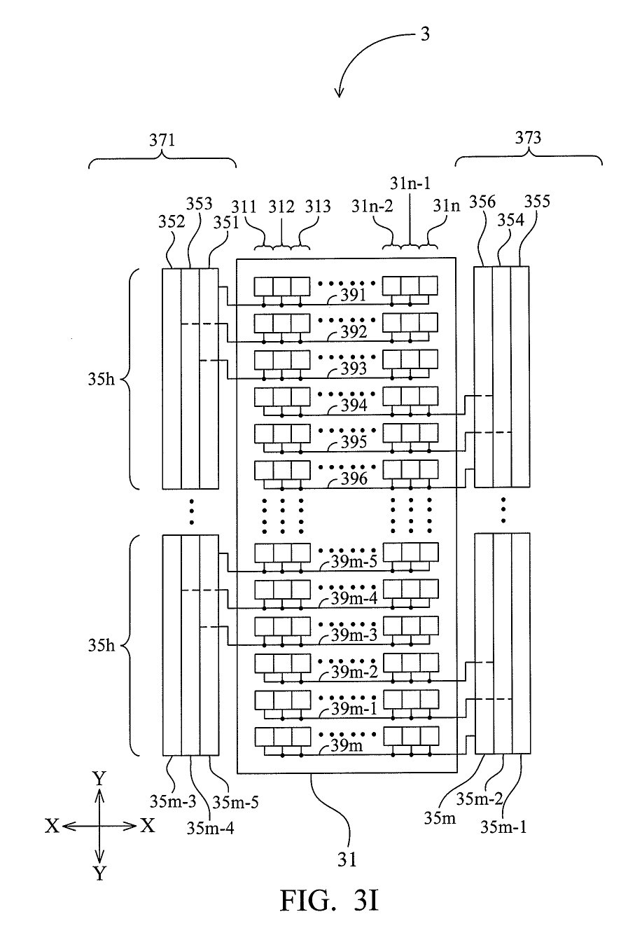

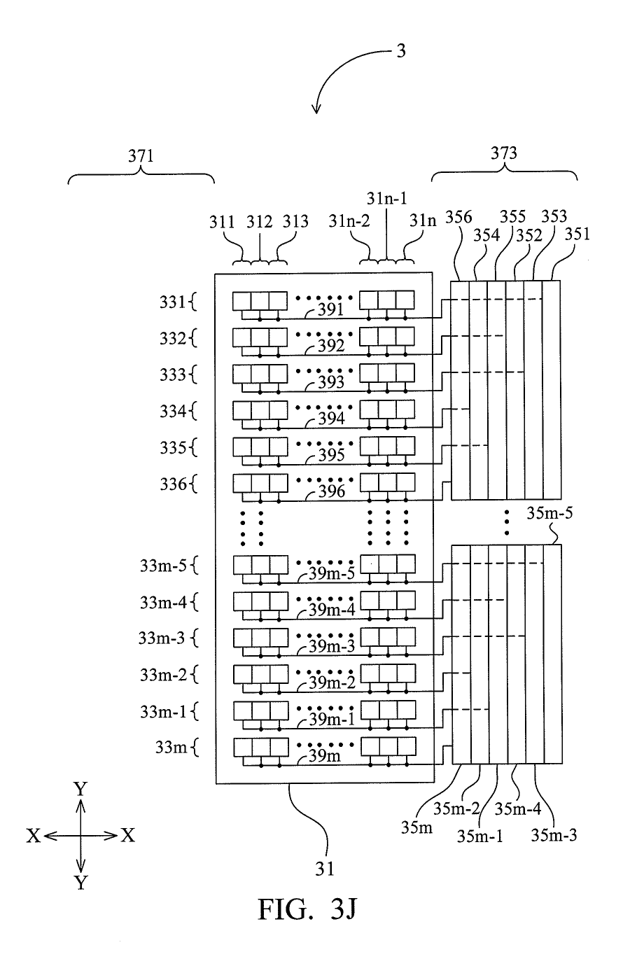

FIGS. 3A to 3J are schematic views of a second embodiment of a pixel array of the present invention. The pixel array 3 comprises a display area 31, a plurality of drivers 351, 352, 353, . . . , 35m and a plurality of scan lines 391, 392, 393, . . . , 39m. For purposes of simplicity, in FIGS. 3A to 3G, only the first driver 351, the second driver 352, the third driver 353, the fourth driver 354, the fifth driver 355 and the sixth driver 356 are shown to represent m drivers of the pixel array 3; and only the first scan line 391, the second scan line 392, the third scan line 393, the fourth scan line 394, the fifth scan line 395 and the sixth scan line 396 are shown to represent m scan lines of the pixel array 3. The drivers 351, 352, 353, . . . , 35m may be different types of drivers such as unidirectional shift registers or bidirectional shift registers.

The display area 31 has a first side 371, a second side 373 in opposition to the first side 371 and a plurality of pixels. The pixels of the display area 31 are arranged along a first direction (Y direction) in sequence to form n columns of pixels (311, 312, 313, . . . , 31n) and, meanwhile, are arranged along a second direction (X direction) in sequence to form m rows of pixels (331, 332, 333, . . . , 33m); i.e., the display area 31 comprises n×m pixels. Like the pixel array 2 described in the first embodiment, in the pixel array 3 of the second embodiment, the m rows of pixels (331, 332, 333, . . . , 33m) formed by pixels arranged along the second direction (X direction) in sequence have a height 33h respectively; similarly, for purposes of simplicity, in FIGS. 3A to 3G, only the first row of pixels 331, the second row of pixels 332, the third row of pixels 333, the fourth row of pixels 334, the fifth row of pixels 335 and the sixth row of pixels 336 are shown to represent m rows of pixels of the display area 31.

Each pixel is electrically connected to a driver via a scan line. For example, each of the first row of pixels 331 is electrically connected to the first driver 351 via the first scan line 391; each of the second row of pixels 332 is electrically connected to the second driver 352 via the second scan line 392; and so on. Finally, each of the m^{th} row of pixels 33m is electrically connected to the m^{th} driver 35m via the m^{th} scan line 39m. The plurality rows of pixels 331, 332, 333, . . . , 33m of the display area 31 will be turned on respectively in sequence according to a timing sequence of a plurality of scan signals generated by the drivers 351, 352, 353, . . . , 35m.

Furthermore, each of the drivers 351, 352, 353, . . . , 35m of the pixel array 3 has a height 35h, which is an even multiple or an odd multiple of the aforesaid height 33h of each row of pixels.

As shown in FIG. 3A, in the pixel array 3 of the second embodiment, the height 35h of each of the drivers 351, 352, 353, . . . , 35m is six times of the height 33h of each row of pixels. Accordingly, the drivers 351, 352, 353, . . . , 35m will be arranged in groups of six (for example, with the first driver 351, the second driver 352, the third driver 353, the fourth driver 354, the fifth driver 355 and the sixth driver 356 forming a group), on the first side 371 of the display area 31 along a second direction (X direction) orthogonal to the first direction (Y direction) in sequence to form a circuit layout of drivers arranged in a two-dimensional manner.

It should be particularly noted that the drivers 351, 352, 353, . . . , 35m which are arranged in groups of a plurality of drivers are not limited to be located on the first side 371 of the display area 31 in the present invention. Those of ordinary skill in the art may locate the drivers 351, 352, 353, . . . , 35m on the first side 371 and the second side 373 of the display area 31 respectively depending on practical requirements.

As shown in FIG. 3B, the first driver 351, the second driver 352, the third driver 353, the fourth driver 354 and the fifth driver 355 are arranged on the first side 371 of the display area 31 along the second direction (X direction) orthogonal to the first direction (Y direction) in sequence, while the sixth driver 356 is located on the second side 373 of the display area 31.

As shown in FIG. 3C, the first driver 351, the second driver 352, the third driver 353 and the fourth driver 354 are arranged on the first side 371 of the display area 31 along the second direction (X direction) orthogonal to the first direction (Y direction) in sequence, while the fifth driver 355 and the sixth driver 356 are arranged on the second side 373 of the display area 31 along the second direction (X direction) orthogonal to the first direction (Y direction) in sequence.

As shown in FIG. 3D, the first driver 351, the second driver 352 and the third driver 353 are arranged on the first side 371 of the display area 31 along the second direction (X direction) orthogonal to the first direction (Y direction) in sequence, while the fourth driver 354, the fifth driver 355 and the sixth driver 356 are arranged on the second side 373 of the display area 31 along the second direction (X direction) orthogonal to the first direction (Y direction) in sequence.

As shown in FIG. 3E, the first driver 351 and the second driver 352 are arranged on the first side 371 of the display area 31 along the second direction (X direction) orthogonal to the first direction (Y direction) in sequence, while the third driver 353, the fourth driver 354, the fifth driver 355 and the sixth driver 356 are arranged on the second side 373 of the display area 31 along the second direction (X direction) orthogonal to the first direction (Y direction) in sequence.

Further, as shown in FIG. 3F, the first driver 351 is located on the first side 371 of the display area 31, while the second driver 352, the third driver 353, the fourth driver 354, the fifth driver 355 and the sixth driver 356 are arranged on the second side 373 of the display area 31 along the second direction (X direction) orthogonal to the first direction (Y direction) in sequence.

Also as shown in FIG. 3G, the first driver 351, the second driver 352, the third driver 353, the fourth driver 354, the fifth driver 355 and the sixth driver 356 are all arranged on the second side 373 of the display area 31 along the second direction (X direction) orthogonal to the first direction (Y direction) in sequence.

Meanwhile, as shown in FIGS. 3H to 3J, the present invention also has no limitation on the sequence in which the drivers 351, 352, 353, . . . , 35m are arranged; i.e., the drivers 351, 352, 353, . . . , 35m may be arranged on the first side 371 and/or the second side 373 of the display area 31 in an interlaced manner. Those of ordinary skill in the art may locate the drivers 351, 352, 353, . . . , 35m on the first side 371 and the second side 373 of the display area 31 in different arrangement sequences depending on practical requirements.

Thus, the pixel array 3 described in the second embodiment has a circuit layout of the drivers 351, 352, 353, . . . , 35m arranged in a two-dimensional manner. Accordingly, in the pixel array 3, the circuit layout of the drivers 351, 352, 353, . . . , 35m has a length thereof diminished so that a frame length of a flat panel display incorporating the pixel array 3 is diminished accordingly.

In summary, the pixel array of the present invention has a circuit layout of drivers arranged in a two-dimensional manner without dramatically altering the construction of the pixel array and the circuit layout of drivers. Accordingly, in the pixel array of the present invention, the circuit layout of drivers has a length thereof diminished so that a frame length of the flat panel display incorporating the pixel array of the present invention is diminished accordingly, thereby producing a flat panel display with an increased number of pixels and a diminished volume.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A pixel array, comprising:
a display area having a first side, a second side in opposition to the first side and a plurality of pixels, wherein the pixels are arranged along a first direction in sequence; and
a plurality of drivers being electrically connected to the pixels, respectively, wherein the drivers are located on the first side and the second side of the display area and are arranged along a second direction in sequence;
wherein the first direction is orthogonal to the second direction.

2. The pixel array as claimed in claim 1, wherein a height of each of the drivers is an even multiple of a height of each of the pixels.

3. The pixel array as claimed in claim 2, wherein the drivers are located on one of the first side of the display area and the second side of the display area.

4. The pixel array as claimed in claim 3, wherein the drivers comprise a first driver and a second driver, the pixels comprise a first pixel and a second pixel, the first driver is electrically connected to the first pixel, and the second driver is electrically connected to the second pixel.

5. The pixel array as claimed in claim 1, wherein a height of each of the drivers is an odd multiple of a height of each of the pixels.

6. The pixel array as claimed in claim 5, wherein the drivers are located on one of the first side of the display area and the second side of the display area.

7. The pixel array as claimed in claim 6, wherein the drivers comprise a first driver, a second driver and a third driver, the pixels comprise a first pixel, a second pixel and a third pixel, the first driver is electrically connected to the first pixel, the second driver is electrically connected to the second pixel, and the third driver is electrically connected to the third pixel.

8. The pixel array as claimed in claim 5, wherein the drivers are located on the first side of the display area and the second side of the display area.

9. The pixel array as claimed in claim 8, wherein the drivers comprise a first driver, a second driver and a third driver, the pixels comprise a first pixel, a second pixel and a third pixel, the first driver and the second driver are located on the first side of the display area, the third driver is located on the second side of the display area, the first driver is electrically connected to the first pixel, the second driver is electrically connected to the second pixel, and the third driver is electrically connected to the third pixel.

10. The pixel array as claimed in claim 1, wherein each of the drivers is a shift register.

11. A pixel array, comprising:
a display area having a first side, a second side in opposition to the first side and a plurality of pixels, wherein the pixels are arranged along a first direction in sequence to form a plurality of pixel columns, and are arranged along a second direction in sequence to form a plurality of pixel rows;
a plurality of scan lines being electrically connected to the pixels, respectively; and
a plurality of drivers being electrically connected to the scan lines, respectively, wherein the drivers are located on the first side of the display area and the second side of the display area, and are arranged along the second direction in sequence;
wherein the first direction is orthogonal to the second direction.

12. The pixel array as claimed in claim 11, wherein a height of each of the drivers is an even multiple of a height of each of the pixel rows.

13. The pixel array as claimed in claim 12, wherein the drivers are located on one of the first side of the display area and the second side of the display area.

14. The pixel array as claimed in claim 13, wherein the drivers comprise a first driver and a second driver, the scan lines comprise a first scan line and a second scan line, the first driver is electrically connected to the first scan line, and the second driver is electrically connected to the second scan line.

15. The pixel array as claimed in claim 11, wherein a height of each of the drivers is an odd multiple of a height of each of the pixel rows.

16. The pixel array as claimed in claim 15, wherein the drivers are located on one of the first side of the display area and the second side of the display area.

17. The pixel array as claimed in claim 16, wherein the drivers comprise a first driver, a second driver and a third driver, the scan lines comprise a first scan line, a second scan line and a third scan line, the first driver is electrically connected to the first scan line, the second driver is electrically connected to the second scan line, and the third driver is electrically connected to the third scan line.

18. The pixel array as claimed in claim 15, wherein the drivers are located on the first side of the display area and the second side of the display area.

19. The pixel array as claimed in claim 18, wherein the drivers comprise a first driver, a second driver and a third driver, the scan lines comprise a first scan line, a second scan line and a third scan line, the first driver and the second driver are located on the first side of the display area, the third driver is located on the second side of the display area, the first driver is electrically connected to the first scan line, the second driver is electrically connected to the second scan line, and the third driver is electrically connected to the third scan line.

20. The pixel array as claimed in claim 11, wherein each of the drivers is a shift register.
